(19) United States
(12) Patent Application Publication
(10) Pub. No.: US 2015/0339702 A1
(43) Pub. Date: Nov. 26, 2015

(54) INTEGRATED MEDIA PLANNING AND BUYING

(71) Applicants: Wayne W. Lin, San Francisco, CA (US); Nathalie D. Criou, San Francisco, CA (US); Alexander D. Kinnier, Palo Alto, CA (US)

(72) Inventors: Wayne W. Lin, San Francisco, CA (US); Nathalie D. Criou, San Francisco, CA (US); Alexander D. Kinnier, Palo Alto, CA (US)

(73) Assignee: Google Inc., Mountain View, CA (US)

(21) Appl. No.: 12/478,610

(22) Filed: Jun. 4, 2009

Related U.S. Application Data
(60) Provisional application No. 61/074,509, filed on Jun. 20, 2008.

(51) Int. Cl. G06Q 30/02; G06Q 10/00

(52) U.S. Cl. CPC G06Q 30/0246; G06Q 30/0251

(57) ABSTRACT

Integrated media planning and buying systems and methods are provided. Integrated media planning and buying systems and methods can include integrated media planning and buying. The integrated media planning and buying systems and methods can facilitate creation and management of an advertising campaign, including locating placements which match an advertising campaigns goals, facilitating the purchase of placements, and providing the media plan to an advertising server to serve advertisements associated with the advertising campaign.

### CROSS-REFERENCE TO RELATED APPLICATION

This application claims priority to U.S. Provisional Patent Application Ser. No. 61/074,509, filed Jun. 20, 2008, and entitled “Integrated Media Planning and Buying,” the contents of which are incorporated herein by reference.

### BACKGROUND

This document relates to advertising campaign management.

The Internet enables access to a wide variety of content items, e.g., video and/or audio files, web pages for particular subjects, and news articles. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

Advertisers sometimes attempt to target properties or placements by audience. For example, a luxury car maker might want to advertise on websites where the visitors to the website make more than $100k/year. In such examples, such advertisers attempt to advertise on sites where a high percentage of users have characteristics that the advertiser likes.

However, many of the tools used to provide advertisement management solutions to advertisers are disparate and can be difficult to use. These disparate solutions can lead to frustration on the part of advertisers which may dissuade advertisers from continued advertising or can preclude advertisers from attaining the full benefit of an advertising campaign.

### SUMMARY

In general, the subject matter of this application relates to integration of advertisement campaign management. One aspect of the subject matter described in this specification can be embodied in a method that includes the actions of receiving campaign criteria associated with an advertising campaign; identifying one or more placements and information about the one or more placements corresponding to the criteria; providing the one or more placements and information about the one or more placements to the advertiser; receiving a selection of placements from the advertiser, the selection identifying placements selected from the placements provided to the advertiser; providing one or more advertisement purchasing plans to the advertiser, the one or more advertisement purchasing plans comprising processes used to purchase an advertisement placement from among the selected placements; receiving a selection of the one or more advertisement purchasing plans; and collecting performance data from one or more purchased advertisement placements. Other embodiments of this aspect include corresponding methods, apparatuses, and computer program products.

Another aspect of the subject matter described in this specification can be embodied in a method that includes the actions of receiving current campaign criteria associated with a current advertising campaign, the current campaign criteria being received from an advertiser; receiving previous campaign information comprising information about previous advertising campaigns occurring before the current advertising campaign; modifying the campaign criteria based upon the previous campaign information; and providing one or more potential advertisement placements to the advertiser, the potential advertisement placements corresponding to the modified campaign criteria. Other embodiments of this aspect include corresponding methods, apparatuses, and computer program products.

Another aspect of the subject matter described in this specification can be embodied in a method that includes the actions of receiving current campaign criteria associated with a current advertising campaign, the current campaign criteria being received from an advertiser, the current campaign criteria comprising demographic information about an audience the advertiser is targeting; retrieving demographic data associated with a plurality of placements; identifying one or more potential advertisement placements corresponding to the current campaign criteria, including demographic information; providing the one or more potential advertisement placements to the advertiser. Other embodiments of this aspect include corresponding methods, apparatuses, and computer program products.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIG. 2 is a block diagram of an example integrated media planning and buying system.

FIGS. 3A-3K are screen shots of example integrated media planning and buying interfaces.

FIG. 4 is a flow diagram of an example process for integrated media planning and buying.

FIG. 5 is a flow diagram of another example process for integrated media planning and buying.

FIG. 6 is a flow diagram of another example process for identifying potential advertising placements based on campaign criteria.

Like reference numbers and designations in the various drawings indicate like elements.

### DETAILED DESCRIPTION

Integrated media planning and buying systems can integrate the planning, buying, ad serving, and tracking aspects of online advertising. Advertisers can use integrated media planning and buying systems to plan advertising campaigns by researching advertisement placements (e.g., websites selling advertising space). The integrated media planning and buying systems are further operable to buy advertisement placements and to track advertisement campaigns against goals. In some implementations, a research tool for the integrated media planning and buying system can pull information from previous campaigns to facilitate identification of a target audience.

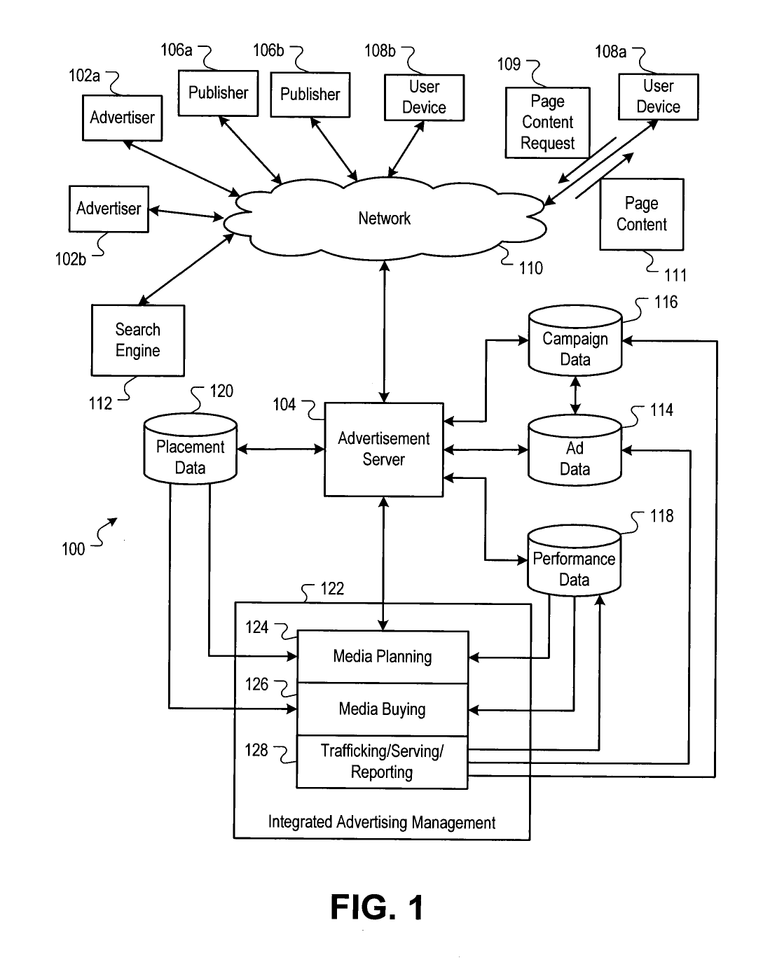

FIG. 1 is a block diagram of an example online environment 100. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement server 104, publishers 106a and 106b, user devices 108a and 108b, and a search engine 112. Although only two advertisers (102a and 102b), two publishers (106a and 106b) and two user devices (108a and 108b) are shown, the online environment 100 may include many thousands of advertisers, publishers and user devices.

In some implementations, one or more advertisers 102a and/or 102b can directly, or indirectly, enter, maintain, and track advertisement information in the advertisement server 104. The advertisements can be in the form of graphical advertisements, such as banner advertisements, text only advertisements, image advertisements, audio advertisements, video advertisements, advertisements combining one of more of any of such components, etc., or any other type of electronic advertisement document 120. The advertisements may also include embedded information, such as a links, meta-information, and/or machine executable instructions, such as HTML or JavaScript™.

A user device, such as user device 108a, can submit a page content request 109 to a publisher or the search engine 112. In some implementations, the page content 111 can be provided to the user device 108a in response to the request 109. The page content can include advertisements provided by the advertisement server 104, or can include executable instructions, e.g., JavaScript™, that can be executed at the user device 108a to request advertisements from the advertisement server 104. Example user devices 108 include personal computers, mobile communication devices, television set-top boxes, etc.

Advertisements can also be provided for the publishers 106. For example, one or more publishers 106a and/or 106b can submit advertisement requests for one or more advertisements to the server 104. The server 104 responds by sending the advertisements to the requesting publisher 106a or 106b for placement on one or more of the publisher's web properties (e.g., websites and other network-distributed content). The advertisements can include embedding links landing pages, e.g., pages on the advertisers 102 websites, that a user is directed to when the user clicks an ad presented on a publisher website. The advertisement requests can also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the server 104. This combined page content 109 and advertisements can be sent to the user device 108 that requested the content (e.g., user device 108a) as page content 111 for presentation in a viewer (e.g., a browser or other content display system). The publisher 106 can transmit information about the advertisements back to the advertisement server 104, including information describing how, when, and/or where the advertisements are to be rendered (e.g., in HTML or JavaScript™).

Publishers 106a and 106b can include general content servers that receive requests for content (e.g., articles, discussion threads, music, video, graphics, search results, web page listings, information feeds, etc.), and retrieves the requested content in response to the request. For example, content servers related news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). An exemplary search engine 112 is described in the article S. Brin and L. Page, “The Anatomy of a Large-Scale Hypertextual Search Engine,” Seventh International World Wide Web Conference, Brisbane, Australia and in U.S. Pat. No. 6,285,999. Search results can include, for example, lists of web page titles, snippets of text extracted from those web pages, and hypertext links to those web pages, and may be grouped into a predetermined number of (e.g., ten) search results.

The search engine 112 can also submit a request for advertisements to the server 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search engine 112 can combine the search results with one or more of the advertisements provided by the server 104. This combined information can then be forwarded to the user device 108 that requested the content as the page content 111. The search results can be maintained as distinct from the advertisements, so as not to confuse the user between paid advertisements and presumably neutral search results.

The advertisers 102, user devices 108, and/or the search engine 112 can also provide usage information to the advertisement server 104. This usage information can include measured or observed user behavior related to advertisements that have been served, such as, for example, whether or not a conversion or a selection related to an advertisement has occurred. The server 104 performs financial transactions, such as crediting the publishers 106 and charging the advertisers 102 based on the usage information. Such usage information can also be processed to measure performance metrics, such as a click-through rate (“CTR”), conversion rate, etc.

A click-through can occur, for example, when a user of a user device, selects or “clicks” on a link to a content item returned by the publisher or the advertisement server 104. The CTR is a performance metric that is obtained by dividing the number of users that clicked on the content item, e.g., a link to a landing page, an advertisement, or a search result, by the number of times the content item was delivered. For example, if a link to a content item is delivered 100 times, and three persons click on the content item, then the CTR for that content item is 3%. Other usage information and/or performance metrics can also be used.

A “conversion” occurs when a user consummates a transaction related to a previously served advertisement. What constitutes a conversion may vary from case to case and can be determined in a variety of ways. For example, a conversion may occur when a user clicks on an advertisement, is referred to the advertiser's web page, and consummates a purchase there before leaving that web page. A conversion can also be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Other actions that constitute a conversion can also be used.

Advertisements and associated usage data can be stored as advertisement data in an advertisement data store 114. In some implementations, an advertiser 102 can further manage the serving of advertisement by specifying an advertising campaign. The advertising campaign can be stored in campaign data in a campaign data store 116 that can, for example, specify advertising budgets for advertisements, when, where and under what conditions particular advertisements may be served for presentation, etc. For example, a computer company may design an advertising campaign for a new laptop computer that is scheduled to be released in several weeks. The advertising campaign may have a budget of $500,000, and may have 30 different advertisements that are to be served for presentation during the month of November. Such data defining the advertisement campaign can be stored in the campaign data 116.

In some implementations, the advertisement server 104 can be coupled to a performance data store 118. The advertisement server 104 can send performance data identifying how well the advertisement is performing. Identification of how well the ad is performing can be based on a performance metric. The performance metric can be defined, for example, in terms of the number of times the advertisement has been served, the number of conversions that have been recorded, or survey information about the advertisement from those viewers that have received the advertisement, among others.

The advertisement server 104 can also be coupled to a placement data store 120. The placement data store 120 can store information on the placements available to serve advertisements. For example, an advertiser, when creating a campaign, can select which of many publishers 106a-b the advertiser would like their advertisement(s) to be placed. However, available placements can change regularly. For example, a publisher 106a-b might go out of business, might switch to another ad server, etc. Thus, available placements for publishers 106a-b can be retrieved from the placement data store 120. In some implementations, the placement data store 120 can store and maintain available placements provided by the advertisement server 104. In other implementations, the placement data store 120 can store and maintain available placements provided by the advertisement server 104 and placements for third party advertisement servers (not shown).

In some implementations, the placement data store 120 can also include demographic information about the types of users that visit a website associated with the placement. Such information can be identified, for example, through survey information. In other examples, such information can be inferred based upon internet navigation activities engaged in by the users, preferably with certain privacy enhancements in place to protect the privacy of individual users. For example, profiles for various categories of users in aggregate can be developed, and other users can be compared against the profile to determine the category with which the other user are associated. These example user category profiles can be developed from sources including but not limited to, for example, social network sites, from users that are participants in demographic panels, by web traffic data collected by advertising networks, user toolbar data, internet service provider data, or by any other scheme that can be used to develop profiles for categories. However, personal information (e.g., including identification, address, IP address, etc.) for such users preferably is not collected or used in profiling. While such information can aid in categorization in some embodiments, preferably private information, such as certain personally identifying information, may be actively removed and/or subjected to “noise” data in order to safeguard private information on behalf of users.

In some implementations, the advertisement server 104 can be connected to an integrated media planning and buying system 122. The integrated media planning and buying system 122 can include a media planning module 124 and a media buying module 126. The integrated media planning and buying system 122 can operate to provide an integrated management solution for advertisers, allowing the advertisers 102a-b to plan advertising campaigns, purchase advertising placements, and track the advertisement campaign through a common interface.

The media planning module 124 can provide an interface to the advertiser to facilitate creation of a new advertising campaign or modification of an existing advertising campaign. In some implementations, the advertiser 102a can use the interface provided by the media planning module to research available advertising placements. The available advertising placements can be retrieved from the placement data store 120.

The advertiser 102a can provide campaign criteria for the advertising campaign. In some implementations, the campaign criteria can include demographic information. The demographic information can indicate a demographic segment the advertiser would like to reach, including, for example, age, gender, income, educational level, etc. Campaign criteria including target demographic information can be identified by the advertiser 102a during the creation or modification of the advertising campaign. In various examples, campaign criteria for a placement search can be specified which define behavioral characteristics of the audience the advertiser is trying to reach (e.g., sites the user has visited). Placements can also be searched based upon the characteristics of the placement itself. For example, a placement might include ads of a certain format, content about a specified topic, specified keywords on the site, and/or has a specified amount of traffic.

In some implementations, the campaign criteria can include goal information. Goal information can include information about the advertising campaign itself. Goal information, for example, can include a budget, target number of impressions, target CTR, target cost per mille (CPM), target conversion rate, etc. Goal information can be collected from the advertiser 120a-b during initial setup of the advertising campaign or modification of the advertising campaign.

In some implementations, the media planning module 124 can use the campaign criteria (e.g., including target demographic information and/or campaign goals) to identify potential advertising placements. The media planning module 124 can query the placement data store 118 to identify the placements which are most relevant to the specified campaign criteria. For example, if the advertiser specifies a target demographic of men, ages 18-34, with a high school diploma making between $30,000 and $80,000 per year, the media planning module 124 can identify placements that most relevant to the target demographic. In other examples, the advertiser 102a might specify campaign goals including a target cost per click along with target demographic information. In such examples, the media planning module 124 can use the campaign goals and the target demographic information to identify the most relevant potential advertisement placements. In still further examples, the advertiser can perform a full audience search by entering information specifying gender (e.g., males), age (e.g., 18-34), income (e.g., $30-80k), and visits sites including, e.g., espn.com, nfl.com, nba.com. In some examples the advertiser can perform a placement search by specifying criteria including ad format/size (e.g., sites that support 250×300 flash ads), in the sports category, and having more than 1 MM monthly pageviews. Using an integrated media planning and buying system can facilitate searching using any combination of the above described criteria.

The most relevant potential advertisement placements can be identified based upon an information retrieval score. In some implementations, the information retrieval score can include a relevance metric. The relevance metric can be derived, for example, based upon how closely the campaign criteria matches the placement information associated with a website. In additional implementations, the information retrieval score can include a quality metric. The quality metric, for example, can be based upon how many users a website reaches. For example, a first website matching the demographic perfectly might only have 10 thousand visitors per month, while a second website that only partially matches the demographic might have 10 million visitors per month. In those implementations where the media placement module 124 measures the quality of a placement, the media placement module 124 might rank a placement associated with the second website above the first website. Other quality metrics can also be used, e.g., a quality rating of the placement based on objective criteria, including, for example: a maximum number of links to other web pages; publisher response time for serving the placement to a client device; inclusion of obscene words or pornography; etc.

In some implementations, the advertiser 120a can provide weightings to specified campaign criteria. For example, the advertiser 120a might decide that he or she is most interested in 18-24 year olds, but would also be interested other age ranges. The media planning module 124 can provide the advertiser 102a with an interface by which to specify weightings associated with the campaign criteria. In other examples, the advertiser 102a can indicate that a particular demographic measurement is more important than the other demographic information. For example, the advertiser 102a might indicate that women are the exclusive target of an advertising campaign. In such examples, the advertiser 102a can indicate that the advertisement campaign is exclusively interested in reaching women. In such examples, the media planning module 124 can identify placements whose website audience is mostly female. Alternatively, the media planning module 124 can ignore the number of male visitors visiting any of the potential placement sites when identifying the potential reach of the placement.

The media planning module 124 can allow the advertiser 102a to provide a selection from among the available placements. The advertiser 102a can select placements, for example, based upon research performed using the media planning module 124. In some implementations, selection of a placement can cause the placement to be added to a media cart. The media cart can provide an area in which a bundle of placements can be stored for analysis and/or purchase.

In some implementations, when a selection of potential advertising placements is made, the selection of potential advertising placements can be analyzed. Analysis of the selection can include aggregating demographics associated with the potential advertising placements. Aggregating the demographics of the potential advertising placements can facilitate understanding of a forecasted reach the selection of potential advertisement placements is projected to have. For example, two websites might reach very similar audiences. In such examples, it is unhelpful to count the reach of the bundle of websites independently. Instead, it is more helpful to determine how much crossover audience there is from one web page to the other. Such crossover visitors can be accounted for, in order to eliminate double counting those visitors. Moreover, other demographics associated with the bundle of websites can be adjusted based upon such crossover visitors. In some implementations, the media planning and buying system can facilitate aggregation of the audiences (e.g., including gender distribution, age distribution, income distribution, etc.) or total traffic across all the placements to provide the advertiser with the ability to better visualize the traffic flow on the combinations of websites.

After adding placements to the media cart, the advertiser 102a can modify the cart. Using such modification of the cart, the advertiser 102a can experiment with different combinations of placements to see which combination of placements gives the advertiser 102a the most benefit.

In some implementations, the advertiser can request to view the detailed statistics associated with a website. The detailed statistics associated with the website, in various examples, can include demographic information associated with the website and/or navigation information associated with the website. For example, the demographic information can break the visitors into age ranges, socioeconomic status, education level, etc. The navigation information, for example, can identify the other sites that users who visited the current placement might have also visited (e.g., during the same session). Such information can be used to provide the advertisers 102a-b a better understanding of the audience reached by the website.

After the advertiser 102a has settled on a selection of media placements, the advertiser 102a can use a media buying module 126 to purchase selected advertising placements. In some implementations, the advertiser 102a can select from among a number of different purchasing plans for advertisement placements. The selection from among the different purchasing plans can be based, for example, on input received from the advertiser 102a.

In some implementations, the purchasing plans can include one or more of a manual buying purchasing plan, an automated reservations buying purchasing plan or an automated auction buying purchasing plan. The manual buying purchasing plan can include a manual buying interface. The manual buying interface can be used to purchase advertisement placements for negotiated advertising spots. A manual buying interface can provide an interface used to communicate with individuals for the purpose of negotiating the purchase of advertising spots for the placement. The interface can facilitate communications between the advertisers and publishers in an electronic format. Contracts can be signed and exchanged using the manual buying interface. In some implementations, payment can be facilitated through the interface.

The automated reservations buying purchasing plan, in some implementations, can facilitate the purchase of future advertising advertisement slot. A reservation can be purchased which enables the user to purchase an advertisement slot during a period, similar to purchasing the option to buy the advertising slot for a given price. Such options can be bought and sold through an automated reservation buying interface. In some implementations the automated reservation buying interface can facilitate buying and selling of such options between advertisers 102a-b (e.g., the options can be transferred to other advertisers).

The automated auction buying purchasing plan can allow advertisers 102a-b to purchase advertising spots in specified placements through an auction process. Such auction processes can facilitate the purchase of advertisement slots in a document in near real-time as the document 111 is being served to a requesting user 108a-b.

In various implementations, the integrated media planning and buying system 122 can include an advertising creative interface for submitting advertising creatives (e.g., an advertisement) to the advertising server 104. Either before or after purchasing advertisement placements or spots using one or more of the purchasing plans, the advertiser 102a can create and submit one or more advertising creatives, for use with the advertising campaign and/or other advertising campaigns. In some advertising campaigns, multiple advertising creatives can be associated with a single campaign, while other advertising campaigns might include only a single advertising creative.

Creatives can be included in the content provided to the user device 108a-b (e.g., page content 111). In other implementations, the creatives can be provided directly to the advertising server.

Once the advertiser 102a has selected a purchasing plan and purchased advertising placements, the purchased selections and campaign information can be packaged into a media plan. The media plan can be provided to an advertising server 104. The advertising server 104 can serve advertisements during the campaign in accordance with the media plan. In some implementations, the media plan can be modified during the campaign. For example, if the advertiser 102a is experiencing a positive response to the campaign, the advertiser 102a might want to extend the campaign, increase the budget and/or run advertisements with additional placements.

In some implementations, the advertising server 104 can capture tracking information from the advertisement campaign. The advertising server 104 can provide the tracking information to a performance data store 118. The performance data store can store performance metrics associated with the advertising campaign. The performance metrics, for example, can include a total number of conversions, a number of conversions associated with each placement, a number of times an advertisement associated with the advertising campaign has been served by a publisher, the number of times an advertisement as clicked by users, the numbers of users the campaign reached, demographic information associated with the users that selected an advertisement associated with the advertising campaign, and demographic information associated with the users that did not select an advertisement associated with the advertising campaign, among many others.

In some implementations, information from the performance data store 118 can be used to modify the media plan and/or the campaign criteria associated with the media campaign. The integrated media planning and buying system 122 can include an optional analysis/reporting module. The analysis/reporting module can modify the media plan to provide better results to the advertising campaign. For example, the system might identify that the campaign is more successful among users of first website versus the users of a second website and can adjust the campaign to account for the greater success on the first website. In other implementations, the integrated media planning and buying system 122 can provide suggestions to the advertiser 102a for modification of the advertising campaign to better target users 108a-b who have historically responded better to either the current advertising campaign or a previous advertising campaign.

At the completion of an advertising campaign, in some implementations, the analysis/reporting module can provide an analysis of the advertising campaign. The analysis of the advertising campaign, for example, can include providing demographic statistics for with individuals who selected the advertisement, demographic statistics for individuals who did not select the advertisement, number of times the advertisement was served at each placement, conversion rate at each placement, total number of conversions, total number of times advertisements associated with the campaign are served, etc. The advertiser 102a can review this information to decide how well the advertising campaign performed, and to identify potential future advertising campaigns.

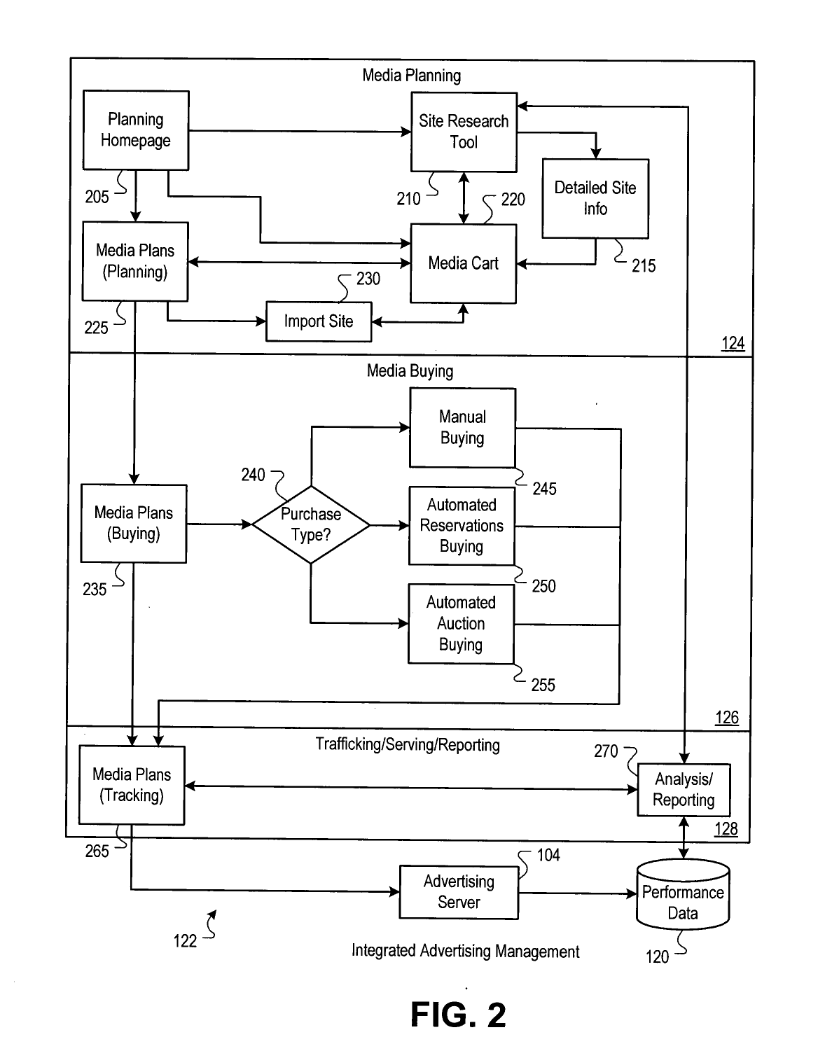

FIG. 2 is a block diagram of an example integrated media planning and buying system 122. In some implementations, an advertiser can begin the integrated media planning and buying using a planning module 124. The planning module 124 can include a planning homepage module 205, a site research tool 210, a detailed site information module 215, a media cart module 220, a media plans (planning) module 225, and an import site module 230.

In some implementations, the planning homepage module 205 can be provide a planning homepage to an advertiser. The planning homepage can provide the advertiser with the ability to create a new media plan, modify an existing media plan or to perform research of advertising placements. If the advertiser chooses to create a new media plan the advertiser can be directed to a media cart page provided by a media cart module. In some implementations, the media cart page can be pre-populated with selections the advertiser has defined as default for his/her advertising campaigns.

In other implementations, the media cart page can be empty to begin the creation of a new advertising campaign. The media cart module 220 can interact with the site research tool 210 to allow the advertiser to provide campaign criteria for the advertising campaign, and to research placements and to add placements to the media cart 220 through pages provided by the media cart module 220 and/or the research tool 210. The campaign criteria using a site research page, for example, can include entry of demographic target data and/or target placement information for research. Upon the entry of campaign criteria, the site research tool 210 can retrieve placements that have the highest information retrieval scores (e.g., composition index) for the campaign criteria and provide select placements to the advertiser through the site research page. The information retrieval scores, in some implementations, can be based upon a relevancy score and/or a quality score. The relevancy score, for example, can be based upon the degree to which a placement matches the campaign criteria. The quality score can be based upon the number of users that visit a website associated with the placement.

In some implementations, the advertiser can use one or more pages provided by the site research tool 210 to retrieve detailed site information page from a detailed site information module 215. The detailed site information page can include detailed demographic and navigation data about a website associated with the placement. For example, the detailed site information page can include information about co-visitation sites. Co-visitation sites can be identified as sites having the most correlated activities over a predefined period of time (e.g., 30 days). More specifically, covisitation sites can be identified those sites which are most likely to be visited when a specified website has been visited. For example, users who visit an ESPN website are most likely to also visit an NBA website in the specified time period. Such co-visitation sites can be provided to give the advertiser a better indication of the types of users that are visiting the website. Co-visitation sites can also provide ideas for alternative placements that might be of interest to the advertiser or can indicate to advertisers that the advertiser might not want to advertise on a placement associated with the co-visitation sites because there may be such a high correlation between the sites that advertising on both sites would not extend the reach of the advertising campaign (e.g., due to the fact that many of the exposures on a co-visitation site may be the same as the ones achieved by a current potential placement). The advertiser can close the detailed information page and return to a media cart page provided by the media cart module 220.

When the advertiser has selected a bundle of placements, the advertiser can proceed to a media plans (planning) page provided by a media plans (planning) page module 225. The media plans (planning) page module 225 can provide an analysis of the aggregate predicted performance (e.g., including demographics information, traffic information, campaign criteria coverage, etc.) for the placements included in the media cart. In some implementations, the advertiser can add or remove placements from the media cart based upon the analysis. The user can add or remove placements by using the import site module 230.

If an advertiser wants to modify an existing campaign, the advertiser can use the planning homepage provided by the planning homepage module 205 to select the advertising campaign he/she would like to modify. The advertiser can be provided with a media plans (planning) page by the media plans (planning) page module 225 in response to his/her selection on the planning homepage. For example, the advertiser might be running an advertising campaign for a “Back to School” campaign and another advertising campaign for a “Labor Day Sale.” If the advertiser would like to modify the “Back to School” campaign, the advertiser can select the “Back to School” campaign and the media planning module can retrieve a media plan associated with the “Back to School” campaign and display the media plan (planning) page associated with the “Back to School” campaign. The advertiser can add or remove placements from the media plan using pages provided by the import site module 230 and the media cart module 220. Additionally, the advertiser can research placements using the site research tool 210 and the detailed site information module 215.

If an advertiser only wants to research sites rather than to create or modify a media plan, the media planning module 124 can provide a site research page through the site research tool 210 to the advertiser without connection to a media plan or advertising campaign. If the advertiser decides to create an advertising campaign while researching placements, the site research page can use the media cart to bundle selected placements and provide the bundled selected placements to a media plan (planning) page 225.

Upon finalizing the media plan (planning) through the media plan (planning) page module 225, the advertiser can select to proceed to a media buying page provided by a media buying module 126. In some implementations, the media buying module can facilitate for the advertiser the purchase of various advertising placements and/or advertising slots. For example, the advertiser might interact the media buying module to communicate with publishers to purchase slots for the publisher's website.

In some implementations, the media buying module 126 can include a media plans (buying) page module 235, a purchase plan decision module 240, a manual buying module 245, an automated reservations buying module 250 and an automated auctions buying module 255. In some implementations, the media plans (buying) page module 235 can provide a buying page which can provide the advertiser with several options for purchasing advertising placements or slots. The purchase plan decision module 240 can determine which of the purchase plans the advertiser has selected from the buying page.

In some implementations, the manual buying module 245 can provide one or more manual buying pages to facilitate the purchase of advertising slots directly from publishers, or from a clearinghouse associated with the publisher. The manual buying module 245 can also provide one or more pages to facilitate electronic communications between the advertiser and the publisher (or clearinghouse). Such electronic communications can include request for pricing on advertising slots, negotiations for the pricing of advertising slots, and facilitate signing contracts between the advertiser and publisher (or clearinghouse). In some implementations, the manual buying module 245 can be used in conjunction with advertising placements or inventory which is provided by a third party (e.g., not the party providing the media planning and buying system 122). For example, when the integrated media planning and buying system 122 is provided by Google Inc. of Mountain View, Calif., and an advertiser wants to advertise with a placement not supported by Google Inc., e.g., a customer that is not a customer of Google Inc., the manual buying module 245 can facilitate communication with the placement (or party representing the placement) in an attempt to negotiate purchase of one or more advertising slots with the placement.

In some implementations, the automated reservation buying module 250 can provide one or more automated buying pages which can facilitate the purchase of a reservation for an advertisement placement. The reservation, for example, can provide the advertiser with the option to purchase an advertisement placement at a future time.

In other examples, the reservation can reserve the advertising placement for the advertiser. In some implementations, the automated reservation buying module 250 can provide one or more pages to create a marketplace for advertisers to buy, sell, and trade reservations in an option-type marketplace. In such implementations, the automated reservation buying module 250 can serve as a clearinghouse for trading such reservations.

In some implementations, the automated auction buying module 255 can provide one or more pages which can facilitate the purchase of advertising placements or slots through an auction process. The auction process can provide advertisers with the ability to purchase advertising slots or placements in near real-time at auction, competing with other advertisers based upon an automated auction process.

Once advertising purchases have been completed, a media plan including placement or spot purchases can be received by a media plan (tracking) page module 265, thereby providing the media plan to the advertising server 104. The media plan (tracking) page module 265 can provide one or more pages offering an opportunity for the advertiser to confirm the advertising campaign before the media plan is released to the advertising server 104. Thus, an advertiser can review the placements, the pricing and the demographics of the media plan prior to release.

In some implementations, the media plan (tracking) page module 265 can also provide one or more pages offering an opportunity for the advertiser to track the advertising campaigns created using the integrated media planning and buying system 122. The advertising server 104 can send performance data to a performance data store 120. Performance data, for example, can include the number of conversions, a statistical distribution of the conversions between placements, a CTR, demographic information associated with exposures and/or conversions, etc. When the advertiser returns to view the media plan (tracking) page provided by the media plan (tracking) page module 265, the performance data can be retrieved from the performance data store 120 by an analysis/reporting module 270. The analysis/reporting module 270 can analyze and aggregate the performance data and provide the analysis to the media plan (tracking) page module 265 for presentation to the advertiser.

In some implementations, the analysis/reporting module 270 can provide analysis of the performance data to the site research tool 210. The site research tool 210 can use the analysis of the performance data to provide context specific research information to the advertiser. In some implementations, the site research tool 210 can automatically adjust campaign criteria or suggest adjustments to the campaign criteria responsive to the analysis of the performance data. The adjustments and/or suggested adjustments can be based upon how well the advertisement campaign is performing on the purchased advertising placements. For example, if the advertising campaign is not performing well on one of the purchased advertising placements, the advertising placement can be removed (or recommended to be removed), thereby preserving advertising budget for other advertising placements that are performing better.

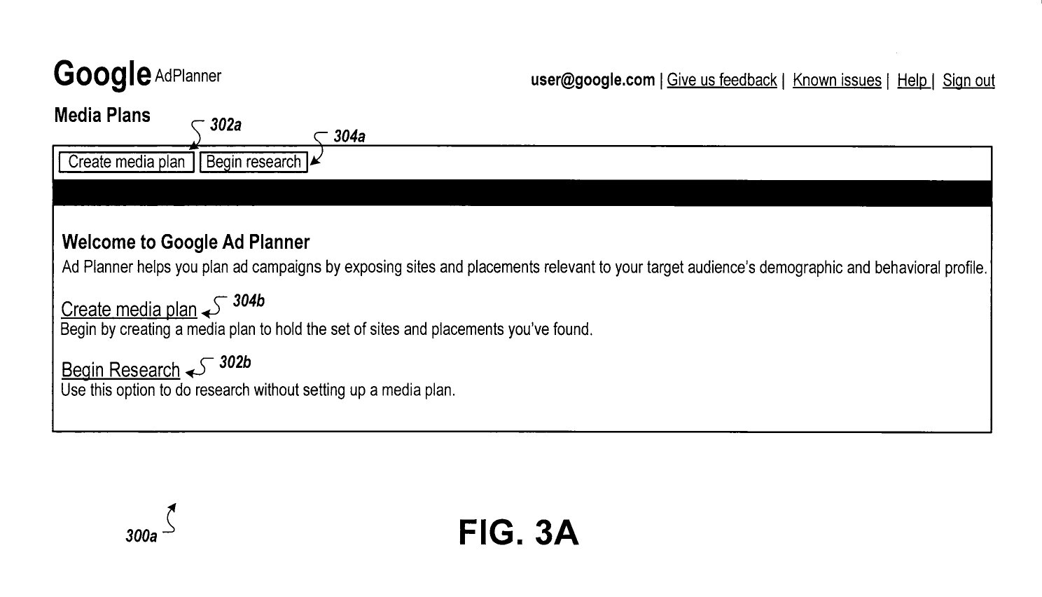

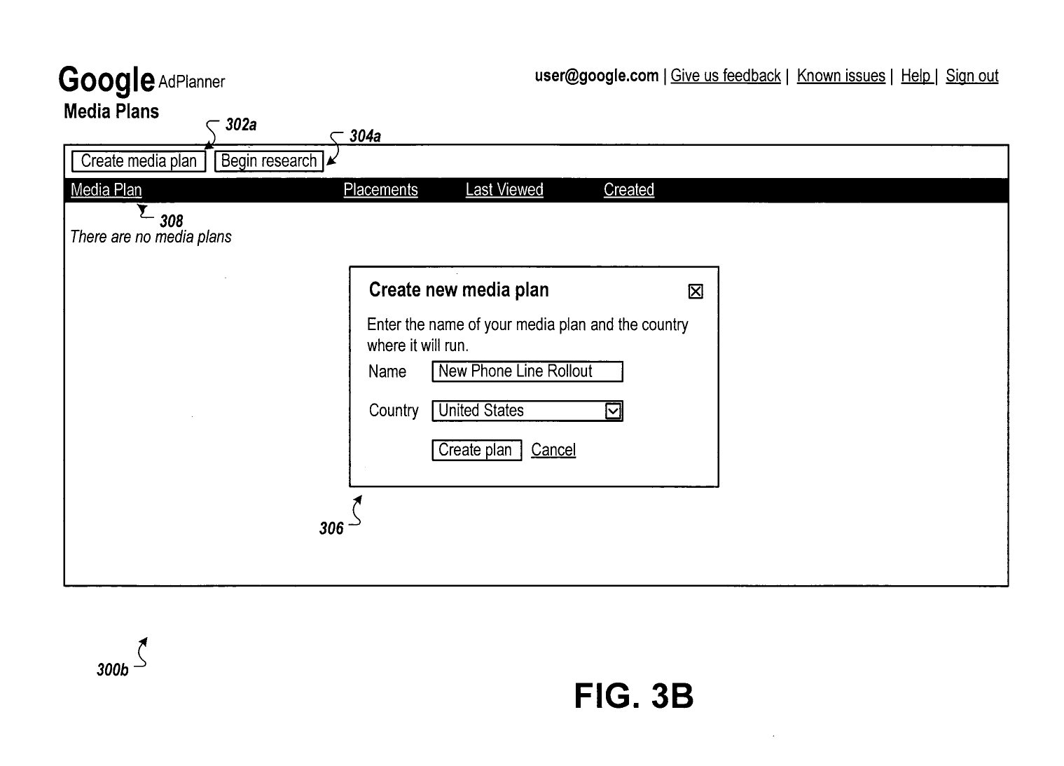

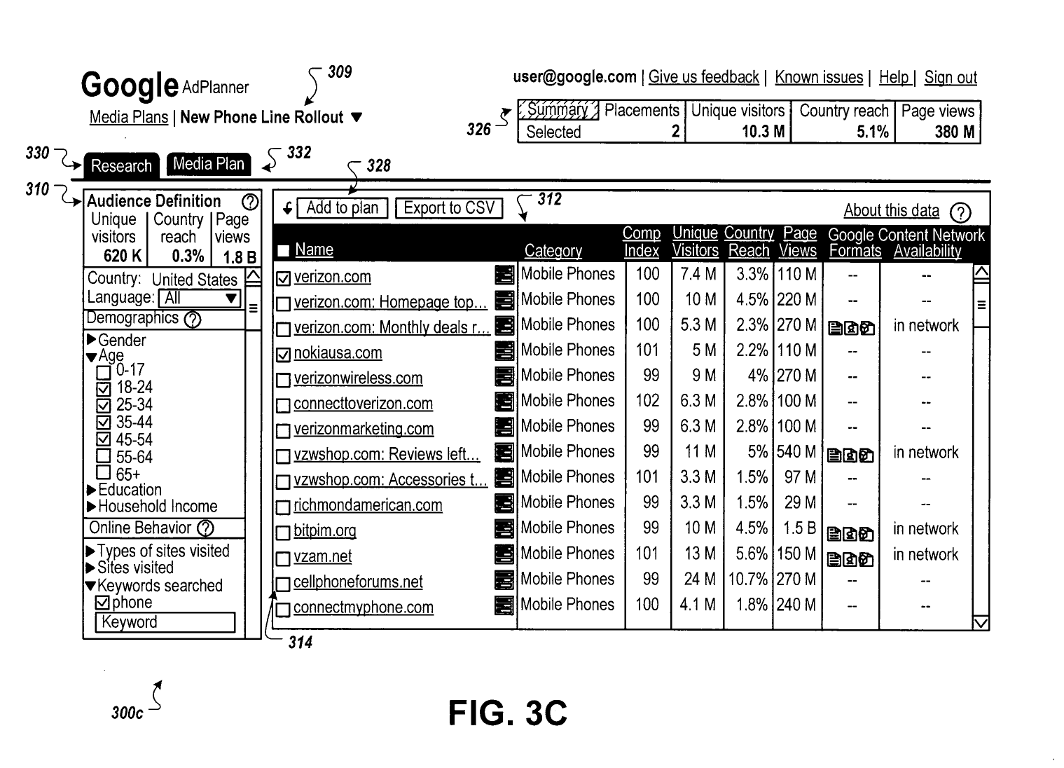

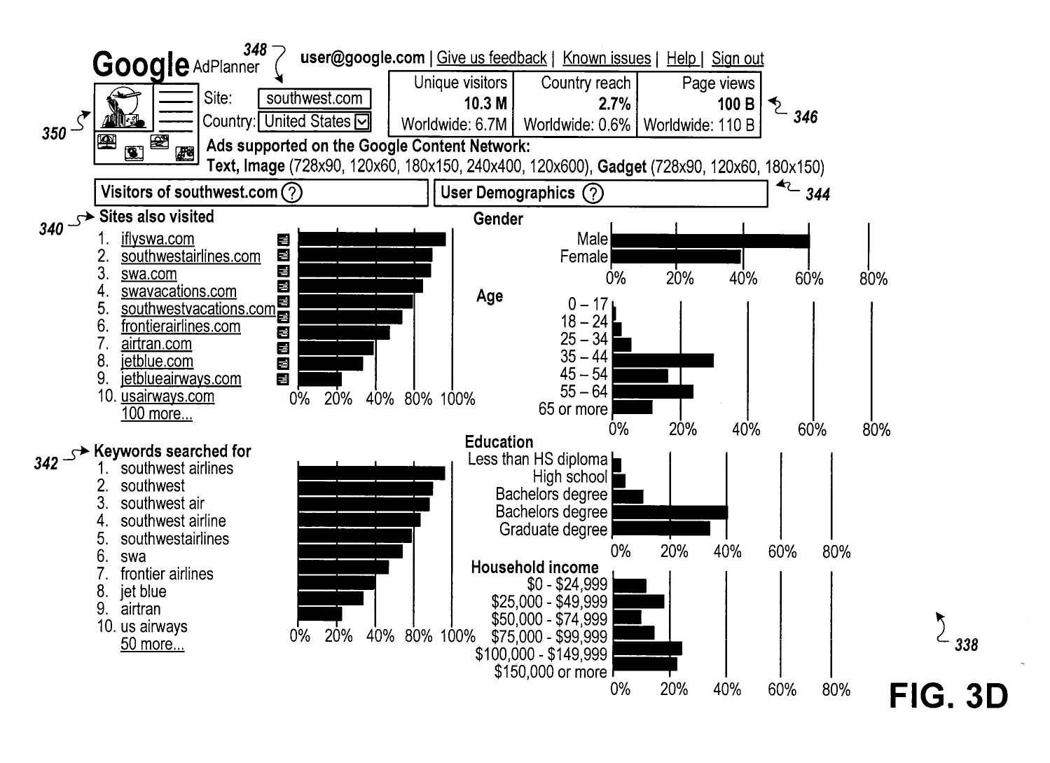

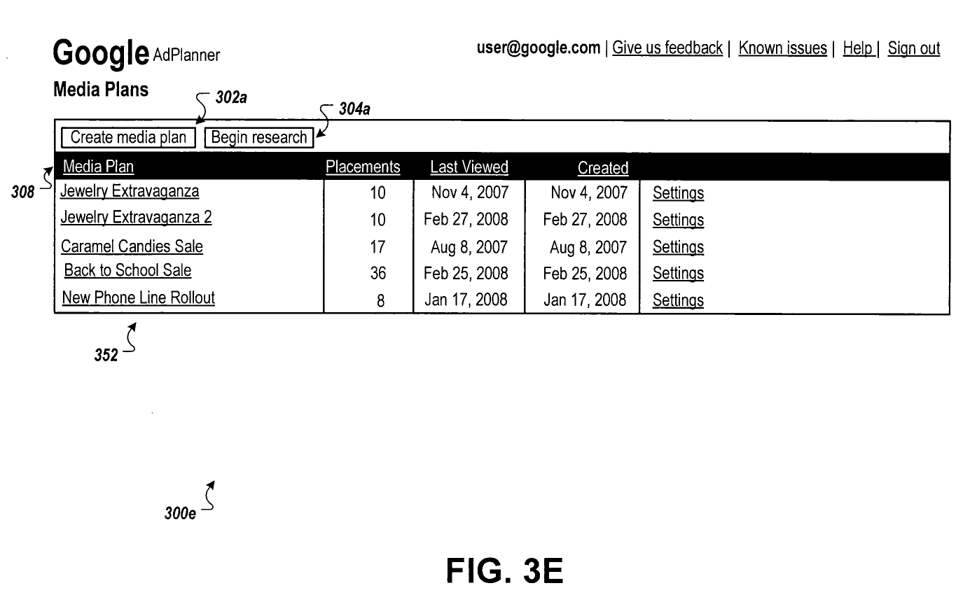

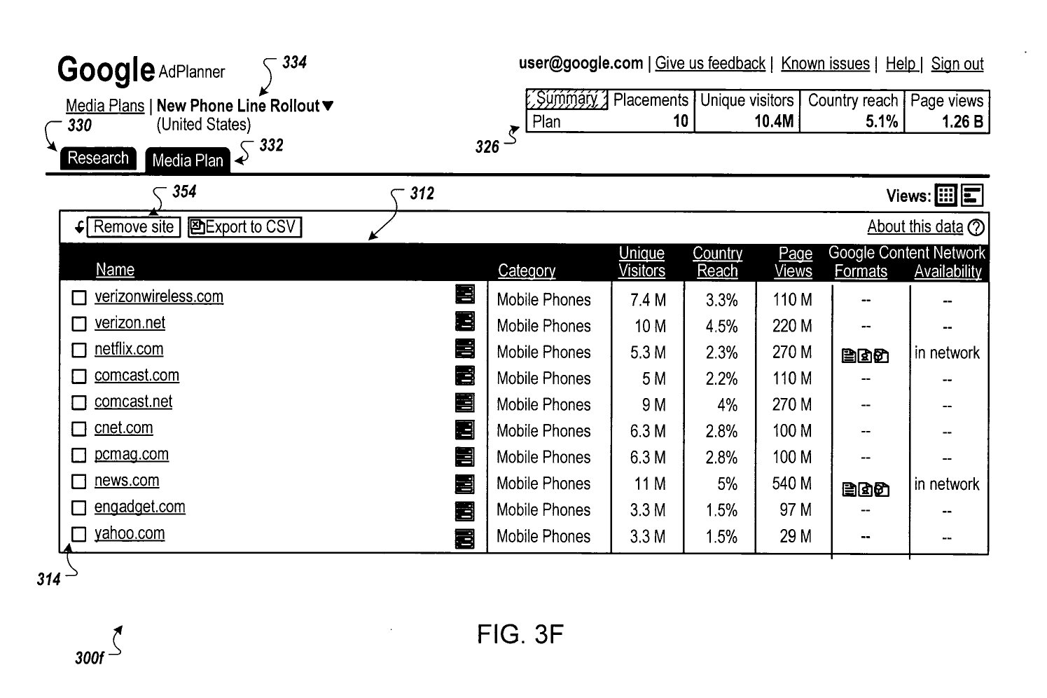

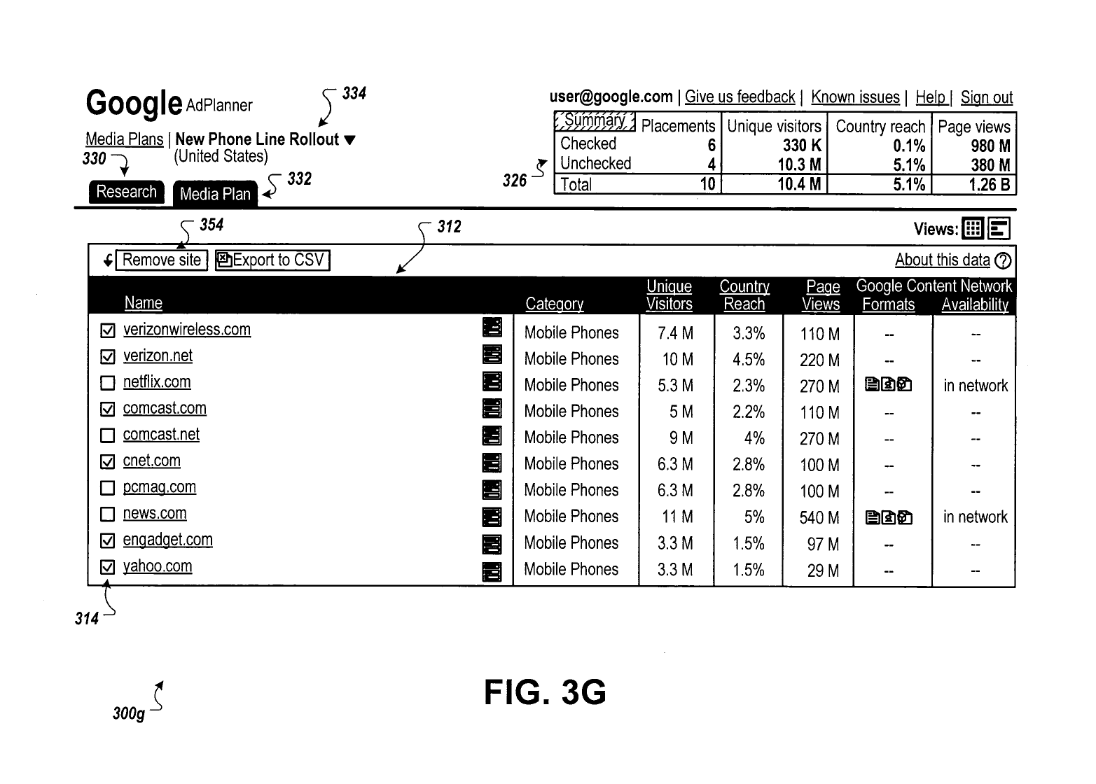

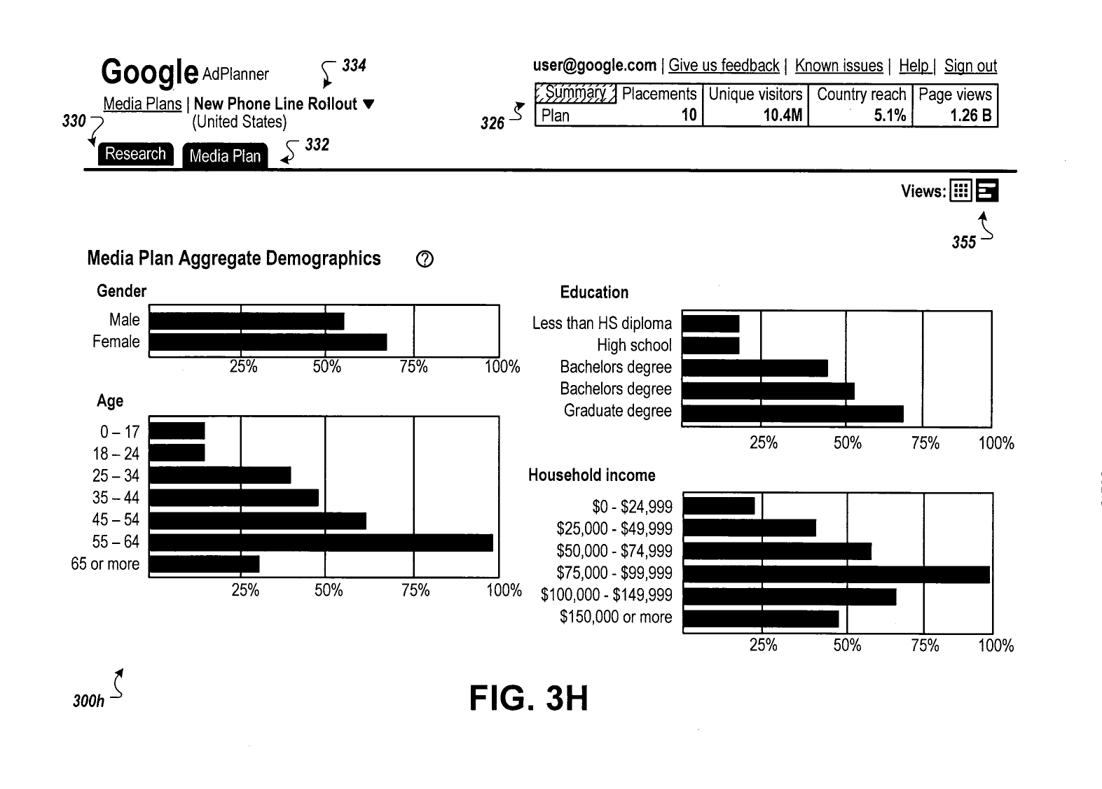

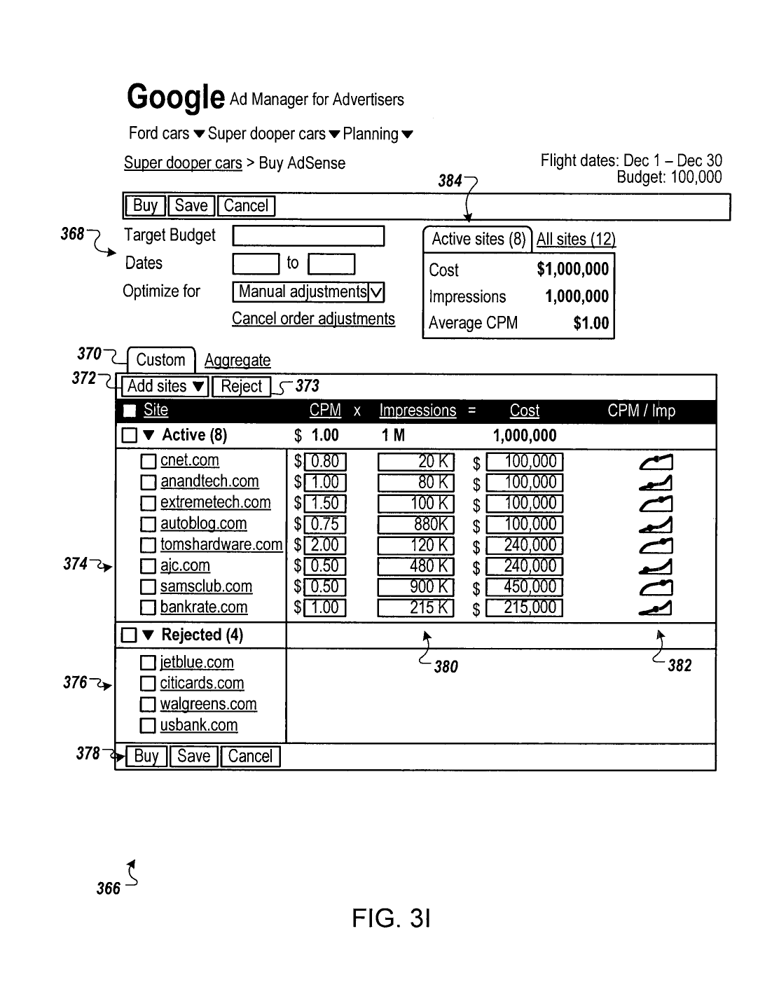

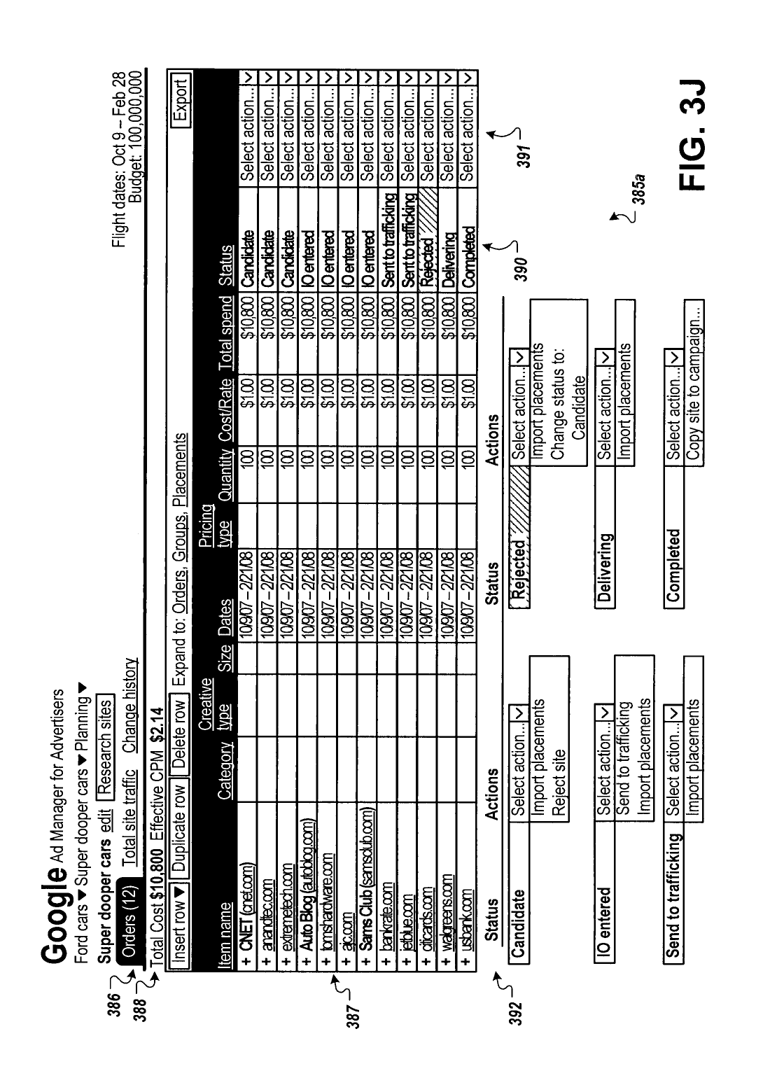

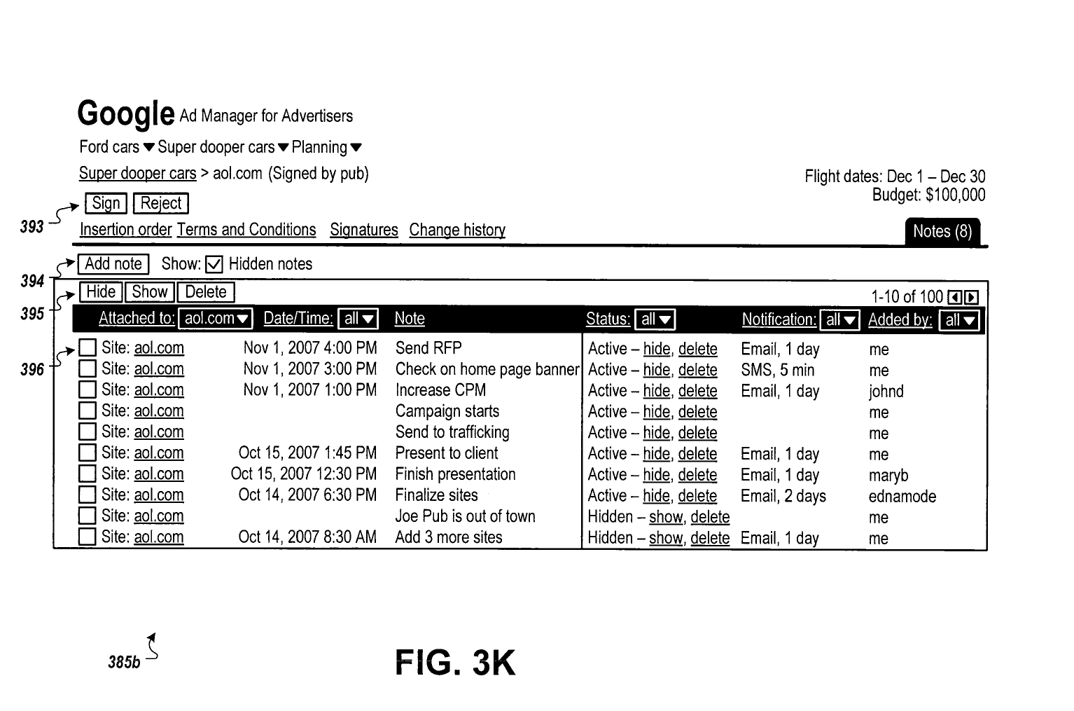

FIG. 3A is a screen shot of an example integrated media planning and buying interface planning homepage 300a. The planning homepage 300a can include a “Create Media Plan” button representation 302a and hyperlink 302b, a “Begin Research” button representation 304a and hyperlink 304b. The “Create Media Plan” button representation 302a and hyperlink 302b when selected request pages allowing the advertiser to create a new media plan or modify an existing media plan. The “Begin Research” button representation 304a and hyperlink 304b when selected request pages allowing the advertiser to research placements.

FIG. 3B is a screen shot of an example integrated media planning and buying interface 300b. The integrated media planning and buying interface 300b can be communicated to the advertiser in response to the advertiser selecting the “Create Media Plan” button representation 302a or hyperlink 302b of FIG. 3A. In those instances where the advertiser has not previously created any advertising campaigns using the integrated media planning and buying system, the interface 300b can present a prompt 306 to the advertiser to create a new media plan. In those instances where the advertiser has previously created an advertising campaign using the integrated media planning and buying system, the previously created advertising campaigns can be listed under a media plan header representation 308. In such instances, the advertiser can select an advertising campaign from the media plan header representation 308 in order to review or modify the media plan associated with the advertising campaign, or the advertiser can select to continue creating the new media plan. Summary details of existing media plans can be included under the media plan header representation. Such summary details can include, for example, media plan name, number of placements, the time the media plan was last viewed, and a time at which the media plan was created.

FIG. 3C is a screen shot of an example integrated media planning and buying research tool interface representation 300c. The integrated media planning and buying research tool interface representation 300c can result from the selection to create a new advertising campaign from interface 300b of FIG. 3B. Research tool Interface representation 300c can include a name field 309 associated with the advertising campaign being created (or modified) by the advertiser. In the example of FIG. 3C, the name of the advertising campaign is “New Phone Line Rollout.”

The research tool interface representation 300c can also include an “Audience Definition” item representation 310. The “Audience Definition” item representation 310 can facilitate the entry of campaign criteria. The campaign criteria can include specification of demographic information about a target audience. The demographic information can include, for example, gender, age, education, and household income, among many others. The campaign criteria can also include specification of online behavior information about a target audience. The online behavior can include, for example, the types of sites visited, particular sites visited, and keywords searched.

In some implementations, placements that most closely match the campaign criteria specified by the advertiser in the “Audience Definition” item representation 310 can be presented to the advertiser in a placement summary item representation 312, including summary information about the placements. Summary information can include, for example, the name of the placement, a general category associated with the placement, a number of unique visitors to web pages associated with the placement, a percentage of the country reached by the placement, a total number of page views, and network availability information. A “comp index” can define the composition index, which can be used as a measure of how well the website matches the audience defined by the advertiser. The network availability information can include, for example, whether the placement can be purchased from the company providing the integrated media planning and buying system and the formats that can be used for advertising. The formats can include, for example, any of text advertisements, graphical advertisements, streaming advertisements, and messaging advertisements. Other formats can be used. The advertiser can select any of the placements by selecting a checkbox representation 314 next to the name of the placement.

In some implementations, the names associated with the placements can be presented in the form of hyperlinks. The hyperlinks can be selected by the advertiser to provide detailed information about the respective placement. The detail information, for example, can include demographic information and navigation information associated with the placement. The demographic information, for example, can include gender information about visitors to the web pages associated with the placement, age distribution about visitors to the web pages associated with placement, and education of the visitors to the web pages associated with the placement. The navigation information can include information about co-visitation habits of the visitors to the one or more web pages associated with the placement.

In some implementations, an aggregate summary 326 of the checked placements can be provided. The aggregate summary 326 can be provided by aggregating the demographic information associated with the checked placements. The aggregate summary 326 can include, for example, a number of placements checked, an aggregate number of unique visitors, a country reach and a total number of page views. In some implementations, the advertiser can customize the information provided within the aggregate summary 326.

In some implementations, the aggregate number of unique views can account for overlap in the number of viewers viewing the combination of the websites. For example, 500 unique viewers might view a first website and 500 unique viewers might visit a second website, while 250 viewers visit both websites. In such examples, the total number of unique viewers reached by the combination of the first website and second website is 750 viewers. Such information can be derived from navigation information associated with the respective websites. Similarly, the country reach can be an aggregate country reach accounting for overlap between the placements.

When the advertiser decides to add a placement to the media plan, the advertiser can select an “Add to plan” button representation 328. The “Add to plan” button representation 328 can request a media plan (planning) page from the media planning module of the integrated media planning and buying system.

The research tool interface representation 300c can also include tab representations 330, 332. The tab representations 330, 332 can be operable to allow the advertiser to switch between a research page (e.g., the page representation of the current figure) using the “Research” tab representation 330 and a media plan page using the “Media Plan” tab representation 332.

FIG. 3D is a screen shot of an example integrated media planning and buying interface for a placement detail page representation 338. The placement detail page representation 338 can result from selection of a hyperlink associated with a placement name. The placement detail page representation 338 can include a “Sites also visited” section 340, a “Keywords searched for” section 342, and a “Demographics” section 344.

The “Sites also visited” section 340 can detail other sites visited by users who visited a web page associated with the selected placement. In some implementations, the “Sites also visited” section 340 can be limited to sites visited in the same session. In other implementations, the “Sites also visited” section 340 can be limited to a specified period of time (e.g., a period of time equal to the duration of the advertising campaign).

The “Keywords searched for” section 342 can detail the keywords that visitors to the selected website searched for in order to arrive at the website. For example, a user that visited a website associated with the placement “southwest.com” during a search session most often searched for “southwest airlines” before selecting the “southwest.com” placement site. Thus, the advertiser can analyze the sort of search terms for which users who visit a placement site search.

The “User demographics” section 344 can include demographics about the users who visit a web page for the placement. The demographics can include, for example, gender, age, educational level, and household income. In some implementations, other demographics can be provided based upon an advertiser's preferences. The demographics can be used by an advertiser to gain a better understanding of the types of visitors who use the placement site, and who would be likely to view the advertisers advertisements if the placement were included in the campaign.

In some implementations, the placement detail page can also include statistical summary of placement traffic 346, identification of the site being detailed 348, and a snapshot of the placement site 350. The summary of the placement traffic 346 can provide information about the overall traffic flow to pages associated with the placement. The identification of the site being detailed 348 provides the name of the current placement, and in some implementations, can be changed to view another placement without returning to the research page (e.g., FIG. 3C). The snapshot of the placement site 350 provides an image of the placement site to help the advertiser understand the organization of the website associated with the placement, and where an advertisement might be placed within the site.

In some implementations, a simpler version of detail page representation 338 can be provided to show basic demographic information for a particular website or combination of websites, based on website query strings entered by advertisers or even the general public. Such a simpler version may be provided to both advertisers and the general public. For example, upon selection of a particular website, a simple interface in a form similar to FIG. 3D may show a representation of unique visitors over time as a snapshot of placement traffic 346, either as text or as a time-based chart with discrete time segments available for selection to give a sense of the website visitor trends over time (such as, for example, 30 day units or larger, thus further preventing distillation of individual information from the aggregate data.) The simpler version of the detail page representation 338 may include, for example, only a “Sites Also Visited” section 340 and a “Keywords Searched For” section 342, where the sites listed include individual links to the listed sites and the keywords searched for include links to the searches common among the aggregate users of the website detailed in the detail page representation 338. Such a simpler version of detail page representation 338 can be integrated with a tool providing other internet trend data, such as, for example, search keyword trends or network traffic trends.

FIG. 3E is a screen shot of an example integrated media planning and buying interface 300e. The example integrated media planning and buying interface 300e of FIG. 3E shows a representation of a web page resulting from selection of the “Create a media plan” button representation 302a or hyperlink 302b of FIG. 3A, when the advertiser has previously created advertising campaigns. In this example, there are several media plans listed under the media plan header 308, including the media plan created for the “New Phone Line Rollout” in FIGS. 3B-D. The advertiser can choose to modify or edit a media plan associated with the campaign by selecting the hyperlink represented by the name of the respective campaign.

FIG. 3F is a screen shot of an example integrated media planning and buying interface 300f. The example integrated media planning and buying interface 300f can result from selection to modify or edit the media plan in FIG. 3E. The “Media Plan” tab representation 332 is selected, so the placement summary item representation 312 can include those placements that have been previously selected for the media plan. The advertiser can modify the plan by selecting to remove any of the placements marked by a checkbox representation 314. The selection to remove the placements marked by the checkbox representation can be provided by the selection of a “Remove site” button representation 354.

In some implementations, the advertiser can add placements to the media plan by selecting the “Research” tab representation 330. Upon selection of the “Research” tab representation, the integrated media planning and buying system can provide the advertiser with a page similar to the page shown in FIG. 3C.

FIG. 3G is a screen shot of an example integrated media planning and buying interface 300g. In the example integrated media planning and buying interface 300g, the advertiser has checked several placements for removal from the media plan using checkbox representations 314. In some implementations, the integrated media planning and buying interface 300g can update the aggregate summary 326 as checkbox representations 314 are selected. In the example shown, six checkbox representations 314 have been selected. The aggregate summary 326 can reflect the summary statistics associated with the checked group of placements and the summary statistics associated with the unchecked group of placements. The advertiser can thereby view how the removal of the checked placements affects the aggregate statistics for the media plan before confirming removal of the checked placements from the media plan by selecting the “Remove site” button representation 354.

In some implementations, a “Views” selection representation 355 can allow the advertiser to view a detailed statistical aggregation of the placements included in the media plan. The detailed statistical aggregation can allow the advertiser to project how the placements interact with each other to forecast the aggregate audience that will be reached by the aggregation of placements.

FIG. 3H is a screen shot of an example integrated media planning and buying interface 300h. The integrated media planning and buying interface 300h can result from selecting the aggregate media plan view from the “Views” selection representations 355. The aggregate demographics can include aggregate gender distribution, aggregate age distribution, aggregate educational distribution, and aggregate income level distribution. The advertiser can use the aggregate distributions to better understand the audience defined by a bundle of placements that have been added to the media cart.

FIG. 3I is a screen shot of an example integrated media planning and buying automated auction buying interface representation 366. The buying interface representation 366 can include a budget and date range specification 368 for the advertising campaign. The buying interface representation 366 can also include tab representations 370 operable to toggle the buying interface representation 366 between a custom buying interface, where each of the placements are purchased separately, and an aggregate buying interface where the placements are purchased in aggregate.

In some implementations, the buying interface representation 366 can include an “Add sites” button representation 372 and a “Reject” button representation 373. The “Add sites” button representation 372 can add sites to the list of active sites 374, while the “Reject” button representation 373 can add sites to the list of rejected sites 376. Checkbox representations accompanying the lists of sites 374, 376 can be used to select the active sites for which to purchase a placement. When the advertisers has selected which of the actives sites for which to purchase a placement, the advertiser can select a “Buy” button representation 378.

In some implementations, pricing and cost information 380 can be provided for those sites listed as active 374. The pricing information can include a cost per mille (CPM) and a number of impressions to estimate a total cost of purchasing the placement. In some implementations, a CPM/Impression statistic 382 can be provided to the advertiser. The CPM/Impression statistic 382 can be provided in a graph form for the advertiser thereby alerting the advertiser to the historical cost of the placement and forecast future cost of the placement. In additional implementations, a summary budget report 384 can be provided to the advertiser. The summary budget report can provide the cost, number of impressions and the average CPM for the active placements.

FIG. 3J is a screen shot of an example integrated media planning and buying manual buying interface 385a. The manual buying interface 385a can include tab representations 386. The tab representations 386 can include an “Order” tab, a “Total site traffic” tab,” and a “Change history” tab. The “Order” tab can facilitate communication between the advertiser and a publisher (or clearinghouse) to manually purchase advertising slots. The “Total site traffic” tab can allow the advertiser to view a summary of the traffic associated with the sites displayed in a site list 387. The “Change history” tab representation can show the history of changes to the media plan. An aggregate summary 388 can show the summary report of the aggregate placements. The aggregate summary 388 can include a total cost and an effective CPM.

In some implementations, the site list 387 can include a status column representation 390. The status column representation 390 can indicate a current status associated with a respective placement from the site list 387. The status column representation 390 can be modified using the “Select action” drop down menu representation 391. The actions that can be selected using the “Select action” drop down menu representation 291, given the current status, are shown in the action key 392. For example, if the current status is “Candidate,” the action key 392 indicates that the actions which can be selected include an “Import placements” action and a “Reject site” action. In another example, if the current status is “Rejected,” the action key 392 indicates that the actions which can be selected include an “Import placements” action and a “Change status to: Candidate” action. Candidate status can indicate that the placement is being negotiated. Rejected status can indicate that the advertiser could not reach agreeable terms with the publisher (or publisher's representative). An 10 entered status can indicate that an insertion order has been entered (e.g., agreed to by both parties). A “Delivering” status can indicate that a request is being delivered to the publisher (or publisher's representative). A “Sent to trafficking” status can indicate that the advertising campaign has been implemented by the advertising server. A “Completed” status can indicate that the placement has been completed.

FIG. 3K is a screen shot of an example integrated media planning and buying manual buying interface representation 385b. In some implementations, the manual buying interface representation 385b can be retrieved in response to the advertiser selecting one of the placement hyperlinks from the site list 387 of FIG. 3J. The manual buying interface representation 385b for a single site can be similar to many electronic mail applications and facilitate communications between the advertiser and a publisher (or publisher's representative). The manual buying interface representation 385b can include, agreement button representations 393, an “Add note” button representation 394, hide/show/delete button representations 395, and a communications list 395 of the communications that have previously passed between the advertiser and the publisher (or publisher's representative) and which have not been deleted.

In some implementations, the agreement button representations 393 can include a “Sign” button representation and a “Reject” button representation. The “Sign” button representation can allow the user to enter into an agreement with the publisher or publisher's representative based on the last proposal made between the parties. The “Reject” button representation can allow the advertiser to discontinue negotiations between the parties. In some examples, the parties may want to discontinue communications when it becomes clear that no agreement can be reached.

In some implementations, the “Add note” button representation can allow the advertiser to post a new communication for sending to the publisher (or publisher's representative). For example, if the publisher previously provided terms and the advertiser would like to counter the terms or clarify some terms, the advertiser can add a note to the negotiation. In some implementations, the note may become part of the agreement unless repudiated by one or more of the parties prior to signing the agreement.

In some implementations, the hide/show/delete button representations 395 can allow the advertiser to modify a list of communications 396 between the advertiser and the publisher (or publisher's representative). A “Hide” button, when selected, can operate to hide communications marked by a selected checkbox representation. In the example shown in FIG. 3K the last two communications are “hidden,” although they still show up because the advertiser has selected a “Hidden notes” checkbox representation. A “Delete” button can delete a selected communication from the list of communications 396. A “Show” button representation can change the status of a “hidden” note to “active.”

In some implementations, the list of communications 396 can display each communication (e.g., notes) between the advertiser and the publisher (or publisher's representative) which has not been deleted. Each note, for example, can include identification of the placement, a date and time stamp identifying when the note was added, a subject of the note, a status associated with the note, a delivery mechanism for the note, and an indication of who added the note.

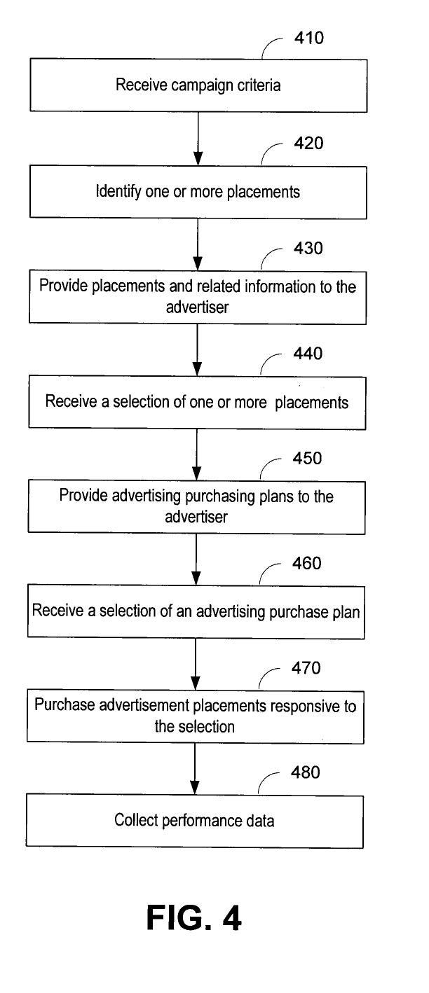

FIG. 4 is a flow diagram of an example process 400 for integrated media planning and buying. At stage 410, campaign criteria is received. The campaign criteria can be received, for example, by a media planning module (e.g., media planning module 124 of FIG. 1). The campaign criteria can include, for example, a target audience for the advertising campaign, a budget for the advertising campaign, a date range for the advertising campaign, search data for web placements, etc. In some implementations, the campaign criteria can be specified through a research tool interface (e.g., research tool interface representation 300c of FIG. 3C).

At stage 420, one or more website placements are identified. The placements can be identified, for example, by a media planning module (e.g., media planning module 124 of FIG. 1). In some implementations, the placements can be identified by an advertiser using a site research tool (e.g., research tool 210 of FIG. 2). The placements can be identified based upon which of the placements in a placement data store have a highest information retrieval score for the campaign criteria specified by the advertiser at stage 410. In some embodiments, the placements can be identified by traversing the placement data 120 and selecting out those placements that match the demographic requirements set by the advertiser as a set of cascading restrictions on the placement data 120. From the data meeting the restrictions, optimization logic such as, for example, a greedy algorithm may be used to isolate a highest ranking set of placements which are to be presented to the user.

At stage 430, placements and related information can be provided to the advertiser. Placements and related information can be provided to the advertiser, for example, by a media planning module (e.g., media planning module 124 of FIG. 1).

The placements provided to the advertiser can be those placements identified at stage 420. The related information can be, for example, demographic information and/or navigation information for one or more web pages associated with the placements provided to the user. In some examples, the related information can include summary demographic and/or navigation statistics associated with the placement.

At stage 440, a selection of one or more placements can be received. The selection of one or more placements can be received, for example, by a media planning module (e.g., media planning module 124 of FIG. 1). In some implementations, the media planning module can use a media cart (e.g., media cart 220 of FIG. 2) to receive a selection of the one or more placements. The selection of the one or more placements can be received from the advertiser and can indicate which of the placements the advertiser would like to add to the advertising campaign.

At stage 450, advertising purchasing plans can be provided to the advertiser. The advertising purchasing plans can be provided to the advertiser, for example, by a media buying module (e.g., media buying module 126 of FIG. 1). In some implementations, the advertising purchasing plans can include a manual buying plan, an automated reservations buying plan, and an automated auction buying plan. The advertising purchasing plans can allow the advertiser to choose which of the purchasing plans the advertiser would like to use to purchase advertising placements or spots. Other purchasing plans can be provided.

At stage 460, selection of an advertising purchasing plan is received. Selection of the advertising purchasing plan can be received, for example, by a media buying module (e.g., media buying module 126 of FIG. 1). In some implementations, the selection of the advertising purchasing plan can be received, for example, through a media buying interface provided by the media buying module. The selection of the advertising purchasing plan can be limited to those plans provided at stage 450.

At stage 470, an advertisement placement is purchased responsive to the selection. The advertisement placement can be purchased, for example, by a media buying module (e.g., media buying module 126 of FIG. 1). The purchase can be made based upon the selection received at stage 460. In some implementations, the advertiser can specify the terms at which the purchase should be made.

At stage 480, performance data is collected. The performance data can be collected, for example, by an advertising server (e.g., advertising server 104 of FIG. 1) in conjunction with a performance data store (e.g., performance data store 118 of FIG. 1). The analysis/reporting module can include an analysis/reporting module (e.g., analysis/reporting module 270 of FIG. 2) to collect performance data from the performance data store for presenting to the advertiser. In some implementations, advertising criteria and/or the media plan can be modified based upon analysis of the performance data provided by the analysis/reporting module.

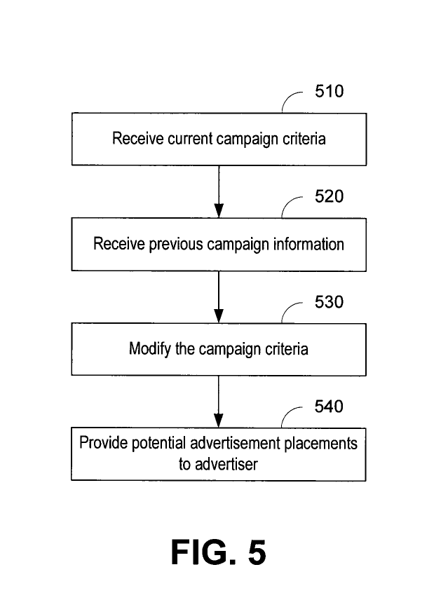

FIG. 5 is a flow diagram of another example process 500 for integrated media planning and buying. At stage 510, current campaign criteria can be received. Current campaign criteria can be received, for example, by a media planning module (e.g., media planning module 124 of FIG. 1). In some implementations, the current campaign criteria can be received from the advertiser in the case of a new campaign or from a campaign data store in the case of an existing advertising campaign.

At stage 520, previous campaign information is received. Previous campaign information can be received, for example, by a media planning module (e.g., media planning module 124 of FIG. 1). The media planning module can receive the previous campaign information from an analysis/reporting module (e.g., analysis/reporting module 270 of FIG. 2). The previous campaign information can include information about how well a similar campaign performed on various placements. Such information can help an advertiser to improve the current campaign.

At stage 530, the campaign criteria can be modified. The campaign criteria can be modified, for example, by a media planning module (e.g., media planning module 124 of FIG. 1). In some implementations, the media planning module can modify the campaign criteria based on previous campaign information received at stage 520. The campaign criteria can be modified so as to maximize the exposures generated by the integrated media planning and buying system. For example, underperforming placements can be eliminated, and other more suitable placements can be identified based upon the previous campaign information.

At stage 540, potential advertising placements are provided to the advertiser. The potential advertising placements are provided to the advertiser, for example, by a media planning module (e.g., media planning module 124 of FIG. 1). In some implementations, the media planning module can use a media plan (planning) page (e.g., media plan (planning) page representation 225 of FIG. 2). The potential advertising placements can be identified and provided based upon the modified campaign criteria from stage 530.

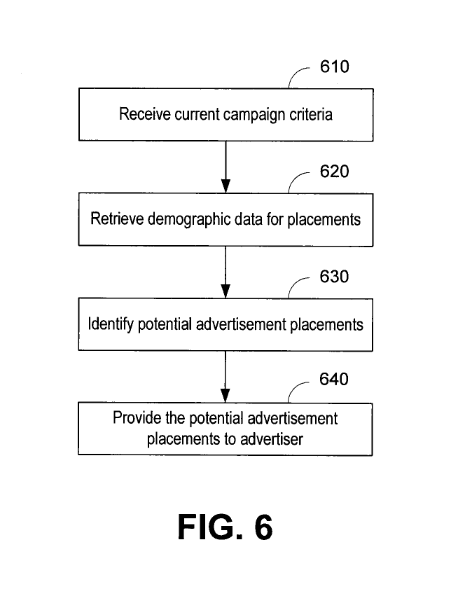

FIG. 6 is a flow diagram of another example process 600 for integrated media planning and buying. At stage 610, current campaign criteria can be received. Current campaign criteria can be received, for example, by a media planning module (e.g., media planning module 124 of FIG. 1). In some implementations, the current campaign criteria can be received from the advertiser in the case of a new campaign or from a campaign data store in the case of an existing advertising campaign. The campaign criteria can include specification of demographic information describing a target audience for the advertising campaign.

At stage 620, demographic data for potential placements can be retrieved. The demographic data can be retrieved, for example, by a media planning module (e.g., media planning module 124 of FIG. 1). In some implementations, demographic data can be retrieved from a placement data store (e.g., placement data store 120 of FIG. 1). The demographic data, for example, can include gender, age, education, and income level information about potential placements.

At stage 630, potential advertisement placements are identified. The potential advertisement placements can be identified, for example, by a media planning module (e.g., media planning module 124 of FIG. 1). In some implementations, the potential advertising placements can be identified based upon an information retrieval score associated with the placements in view of the campaign criteria including how well the retrieved demographic information matches the demographic data specified by the advertiser describing a target audience.

At stage 640, potential advertising placements are provided to the advertiser. The potential advertising placements are provided to the advertiser, for example, by a media planning module (e.g., media planning module 124 of FIG. 1). In some implementations, the media planning module can use a media plan (planning) page (e.g., media plan (planning) page representation 225 of FIG. 2). The potential advertising placements can be identified and provided based upon the modified campaign criteria from stage 630.

The integrated media planning and buying system can be realized by instructions that upon execution cause one or more processing systems to carry out the processes and functions described above. Such instructions can, for example, comprise interpreted instructions, such as script instructions, e.g., JavaScript or ECMAScript instructions, or executable code, or other instructions stored in a computer readable medium. The integrated media planning and buying system can be distributively implemented over a network, such as a server farm, or can be implemented in a single computer device.

Implementations of the subject matter and the functional operations described in this specification can be implemented in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

1. A computer implemented method, comprising:
receiving, by one or more computers, campaign criteria associated with an advertising campaign, the campaign criteria specifying characteristics of a target audience for the advertising campaign;
identifying, by the one or more computers, placements having characteristics corresponding to the criteria, the identified placements being resources with which advertisements are presented;
providing, by the one or more computers and for presentation, traffic measures for the identified placements, the traffic measures for each identified placement including a user count that indicates a number of users that have been provided the identified placement;
receiving selection data specifying a selection of a group of placements that include at least two of the identified placements;
determining, by the one or more computers, a sum of the user counts for the placements in the group of placements;
determining, by the one or more computers and based on the traffic measures, a number of crossover users that were provided two or more different placements in the group of placements;
determining, by the one or more computers and based on a difference between the sum of the user counts and the number of crossover users, an aggregate number of unique users that have been provided at least one placement in the group of placements, the aggregate number of unique users being less than the sum of the user counts and accounts for the number of crossover users and a number of different placements in the group of placements each crossover user was provided;
providing, by the one or more computers, the aggregate number of unique visitors; and
collecting performance data for advertisements presented at the group of placements.

2. The computer implemented method of claim 1, further comprising providing demographic information for users visiting a website associated with a potential placement.

3. The computer implemented method of claim 2, further comprising providing navigation information comprising information specifying:
navigation habits of users that requested presentation of the website; and
other websites that were requested by the users.

4. The computer implemented method of claim 1, further comprising:
aggregating predicted performance information associated with the group of placements; and
providing the aggregated predicted performance information.

5. The computer implemented method of claim 4, further comprising:
determining whether the aggregated predicted performance information is projected to fulfill campaign goals included in the campaign criteria based upon predictions associated with the group of placements; and
providing the determination to an advertiser associated with the advertising campaign.

6. The computer implemented method of claim 5, further comprising:
determining that the aggregated predicted performance information does not fulfill the campaign goals; and
identifying alternative placements that project to fulfill the campaign goals, the alternative placements being different placements than the identified placements in the group of placements; and
providing the alternative placements that project to fulfill the campaign goals.

7. The computer implemented method of claim 6, wherein identification of alternative placements is based upon performance data collected from prior advertising campaigns.

8. The computer implemented method of claim 6, wherein the predicted performance information takes into account one or more of demographic information associated with the selected placements, traffic information associated with the group of placements, or campaign performance information associated with the advertising campaign.

9. The computer implemented method of claim 1, further comprising providing the performance data.

10. The computer implemented method of claim 1, wherein the group of placements includes third party placements.

11. (canceled)

12. A system, comprising:
a data processing apparatus; and
a memory apparatus in data communication with the data processing apparatus and storing instructions executable by the data processing apparatus and that upon such execution cause the data processing apparatus to perform operations comprising:
receiving criteria for an advertising campaign from an advertiser, the criteria specifying characteristics of a target audience for the advertising campaign;
identifying to the advertiser advertising placements having characteristics corresponding to the criteria, the identified advertising placements being resources with which advertisements are presented;
providing to the advertiser traffic measures for the identified advertising placements, the traffic measures for each identified advertising placement including a user count that indicates a number of users that have been provided the identified advertising placement;
receiving selection data specifying a selection of a group of placements that include at least two of the identified advertising placements;
determining a sum of the user counts for the placements in the group of placements;
determining, based on the traffic measures, a number of crossover users that were provided two or more different placements in the group of placements;
determining, based on a difference between the sum of the user counts and the number of crossover users, an aggregate number of unique users that have been provided at least one placement in the group of placements, the aggregate number of unique users being less than the sum of the user counts and accounts for the number of crossover users and a number of different placements in the group of placements each crossover user was provided;
providing to the advertiser the aggregate number of unique users;
receiving purchase data from the advertiser specifying the purchase one or more of the identified advertising placements responsive to input from the advertiser; and
collecting performance data for advertisements presented at the one or more purchased advertising placements and to communicate the performance data to the advertiser.

13. The system of claim 12, wherein the operations further comprise providing demographic information to the advertiser for categories of users visiting a website associated with a potential advertising placement from among the identified advertising placements.

14. The system of claim 13, wherein the operations further comprise providing navigation information comprising information specifying:
navigation habits of users that requested presentation of the website; and
other websites that were requested by the users.

15. The system of claim 12, wherein the operations further comprise adding the group of advertising placements to a site bundle.

16. The system of claim 13, wherein the operations further comprise aggregating predicted performance information associated with the group of advertising placements and to provide the aggregated predicted performance information to the advertiser.

17. The system of claim 16, wherein the site research tool is operable further comprise determining whether the aggregated predicted performance information projects to fulfill campaign goals included in the criteria and to provide the determination to the advertiser.

18. The system of claim 17, wherein the operations further comprise:
identifying alternative placements that project to fulfill the campaign goals based upon performance data collected from prior advertising campaigns, the alternative placements being identified responsive to a determination that the aggregated predicted performance information does not project to fulfill the campaign goals; and
providing the alternative placements to the advertiser.

19. The system of claim 12, wherein the group of advertising placements include third party advertising placements.

20. A computer-implemented method, comprising:
receiving, by one or more computers, current campaign criteria associated with a current advertising campaign, the current campaign criteria being received from an advertiser and specifying characteristics of a target audience for the current advertising campaign;
receiving, by the one or more computers, previous campaign information comprising information about one or more previous advertising campaigns occurring before the current advertising campaign;
modifying, by the one or more computers, the current campaign criteria based upon the previous campaign information to generate modified campaign criteria;
identifying, by the one or more computers, advertising placements having characteristics corresponding to the modified campaign criteria, the identified advertising placements being resources with which advertisements are presented;
providing, by the one or more computers and for presentation to the advertiser, traffic measures for the identified advertising placements, the traffic measures for each identified advertising placement including a user count that indicates a number of users that have been provided the identified advertising placement;
receiving, by the one or more computers, selection data specifying a selection of a group of placements that include at least two of the identified advertising placements;
determining, by the one or more computers, a sum of the user counts for the placements in the group of placements;
determining, by the one or more computers and based on the traffic measures, a number of crossover users that were provided two or more different placements in the group of placements;
determining, by the one or more computers and based on a difference between the sum of the user counts and the number of crossover users, an aggregate number of unique users that have been provided at least one placement in the group of advertising placements, the aggregate number of unique users being less than the sum of the user counts and accounts for the number of crossover users and a number of different placements in the group of placements each crossover user was provided; and
providing, by the one or more computers, the aggregate number of unique users.

21. A computer-implemented method, comprising:
receiving, by one or more computers, current campaign criteria associated with a current advertising campaign, the current campaign criteria being received from an advertiser, the current campaign criteria specifying characteristics of a target audience for the current advertising campaign and comprising demographic information for the target audience;
retrieving, by the one or more computers, demographic data associated with a plurality of advertisement placements;
identifying, by the one or more computers, advertisement placements comprising characteristics corresponding to the current campaign criteria, including demographic information, the identified advertisement placements being resources with which advertisements are presented;
providing, by the one or more computers and to the advertiser, traffic measures for the identified advertisement placements, the traffic measures for each identified advertisement placement including a user count that indicates a number of users that have been provided the identified placement
receiving, by the one or more computers, selection data specifying a selection of a group of advertisement placements that include at least two of the identified advertisement placements;
determining, by the one or more computers, a sum of the user counts for the advertisement placements in the group of advertisement placements;
determining, by the one or more computers and based on the traffic measures, a number of crossover users that were provided two or more different advertisement placements in the group of placements;
determining, by the one or more computers and based on a difference between the sum of the user counts and the number of crossover users, an aggregate number of unique users that have been provided at least one advertisement placement in the group of advertisement placements, the aggregate number of unique users being less than the sum of the user counts and accounting for the number of crossover users and a number of different advertisement placements each crossover user was provided; and
providing, by the one or more computers, the aggregate number of unique users.

22. The computer implemented method of claim 4, wherein determining the aggregate number of unique users that have been provided at least one placement in the group of placements comprises:
aggregating demographic information regarding users that visit a website for each identified placement in the group of placements; and
evaluating the aggregated demographic information to identify the number of crossover users that have been provided two or more different placements in the group of placements,
wherein the aggregated predicted performance information is adjusted to account for the number of crossover users.

23. (canceled)

24. The computer implemented method of claim 1, wherein identifying placements having characteristics corresponding to the criteria comprises:
computing an information retrieval score for each of a plurality of available placements, each information retrieval score comprising a relevancy score and a quality score, the relevancy score being based on a degree of match between the respective placement and the campaign criteria, the quality score being based on a number of users that requested presentation of a website of the respective placement; and
selecting the identified placements from the plurality of available placements based on relevancy score.

25. The computer implemented method of claim 1, further comprising:
identifying, for at least one placement of the identified placements, information identifying at least one additional website accessed by a user that accessed a website associated with the at least one placement; and
providing information regarding the at least one identified additional website to the advertiser.

26. The computer implemented method of claim 1, wherein identifying placements having characteristics corresponding to the criteria comprises:
receiving information regarding a previous advertising campaign comprising previous campaign criteria corresponding to the campaign criteria, the information regarding the previous advertising campaign comprising information identifying a performance of at least one placement for the previous advertising campaign; and
adjusting the campaign criteria based on the identified performance of the at least one placement for the previous advertising campaign,
wherein the identified placements are identified based on the adjusted campaign criteria.

27. The computer implemented method of claim 1, wherein
determining the aggregate number of unique users that have been provided at least one placement in the group of placements comprises:
computing a sum of the user counts for the group of placements;
identifying a first set of users that have been provided a first placement in the group of placements;
identifying a second set of users that have been provided a second placement in the group of placements;
determining a number of users that are included in both the first set and the second set; and
reducing the sum of the user counts by the number of users that are included in both the first set and the second set.

28. The computer implemented method of claim 1, wherein the campaign criteria further specifies a minimum amount of traffic for each potential placement, and wherein identifying, by the one or more computers, placements having characteristics corresponding to the campaign criteria further comprises identifying placements having a user count that exceeds the minimum amount of traffic.

29. The computer implemented method of claim 1, further comprising:
identifying a set of the identified placements that were not selected;
determining, based on the traffic measures, a number of unique users that have received at least one placement in the set of placements; and
providing the number of unique users that have received at least one placement in the set of placements for presentation with the aggregate number of unique visitors.

30. The computer implemented method of claim 29, further comprising:
determining a sum of the aggregate number of unique visitors and the number of unique users that have received at least one placement in the set of placements; and
providing the sum for presentation with the number of unique users that have received at least one placement in the set of placements and the aggregate number of unique visitors.

31. The computer implemented method of claim 1, further comprising:
receiving updated selection data specifying selection of an additional placement from the identified placements;
determining an updated number of unique users that received at least one placement from a set of placements that include the group of placements and the additional placement; and
providing the updated number of unique users for presentation.
